(19) United States
(12) Patent Application Publication
(10) Pub. No.: US 2023/0281700 A1
(43) Pub. Date: Sep. 7, 2023

(54) GAMIFICATION OF DIGITAL GIFT GIVING

(71) Applicant: Chad Lubbers, Bloomington, MN (US)

(72) Inventor: Chad Lubbers, Bloomington, MN (US)

(21) Appl. No.: 18/179,807

(22) Filed: Mar. 7, 2023

Related U.S. Application Data
(60) Provisional application No. 63/317,510, filed on Mar. 7, 2022.

(51) Int. Cl. G06Q 30/0601

(52) U.S. Cl. CPC G06Q 30/0641

(57) ABSTRACT

A system may receive input from a first user which defines the digital gift and certain defined characteristics for a customized gift access process (e.g. a game or puzzle) which will enable a second user to access to the digital gift. The system will then create the customized gift access process based upon the characteristic provided by the first user, which may identify at least one resource needed by the second user and a plurality of steps required by the second user to generate a satisfactory result. The system may then transmit an invitation to participate in the gift access process to the second user, thus providing electronic access to the second user allowing them to participate in the customized gift access process. The system will further transmit and receive information from the second user which allows them to attempt to carry out the created game/puzzle. The system will further determine if the second user has satisfactorily completed the necessary steps, and upon satisfactorily completion, the system will transmit identifying/access information related to the digital gift, thus allowing the second user access and receive the digital gift.

### BACKGROUND

The popularity of electronic commerce has made electronic payments, the transfer/sharing of electronic information, electronic communication, advertising, electronic entertainment, etc., all very well recognized and commonly accepted by individuals, businesses and organizations of all types. Gift cards and electronic gifts have also become a very popular forms of gifting due to the convenience and flexibility provided to both the gift giver and recipient. As is well recognized, the process of giving and receiving electronic/digital gifts is easy for people to use, whether carried out on-line or through a “bricks and mortar” merchant and thus well accepted in today's society.

As digital gift giving has been in existence for quite some time, a very savvy base of customers exist who are accustomed to the purchase, distribution and receipt of digital items: gift cards, web links, photos, videos and other electronic files. However, the distribution of these items is entirely transactional, lacking both the interaction and the personalization associated with physical gift exchange. Digital gift giving/receiving lacks fun, excitement, involvement and interaction, which is typically associated with presenting/receiving physical gifts. As such, there is a need to create a unique digital presentation and unboxing experience.

SUMMARY

This system and process described herein creates small custom-designed digital games/puzzles which function as solvable passkeys, granting access to a digital gift that is transmitted from one user to another. This invention will utilize technological assets inherent in mobile computing devices—camera, microphone, keypad, GPS—along with unique solutions to utilize these tools in a manner that allows users to create customizable games or puzzles that are unique to both the gift giver and the gift recipient. This customized game or puzzle must then be solved to open/unlock the digital gift being sent. The systems and methods further provide specific programming approaches to ensure the game or puzzle, digital gift, and information related to the parties involved are kept confidential. Further, steps are taken to efficiently achieve required steps in the process of gift giving/receiving so that computing resources are not overly stressed.

In some aspects, the techniques described herein relate to a method of giving and receiving a digital gift, including: receiving input from a first user which defines the digital gift; providing a user interface to the first user configured to allow the first user to define the characteristics of a customized gift access process which will enable a second user to access to the digital gift; creating the gift access process based upon the characteristic received from the first user, wherein the customized gift access process will identify at least one resource needed by the second user and a plurality of steps required by the second user to generate a satisfactory result; transmitting an invitation to participate in the gift access process to the user, wherein the invitation provides electronic access allowing the user to participate in the gift access process using a second user interface provided to the second user; transmitting information to the second user and receiving information from the second user to allow the second user to attempt to carry out the plurality of steps using the second user interface and the at least one resource; determining if the second user has satisfactorily completed the plurality of steps, and upon satisfactorily completing the plurality of steps, transmitting identifying information and access information related to the digital gift thereby allowing the second user to receive the digital gift.

In some aspects, the techniques described herein relate to a method using the user interface is on a personal computing device of the second user and wherein the at least one resource includes a utility such as a camera, audio recorder or GPS device.

In some aspects, the techniques described herein relate to a method wherein the customized gift access process is a game played on the personal computing device.

In some aspects, the techniques described herein relate to a method wherein the game requires the use of a GPS receiver contained within the personal computing device to generate location information.

### BRIEF DESCRIPTION OF THE DRAWINGS

FIG. 1 illustrates one embodiment of the infrastructure needed to carry out the desired gifting process.

FIG. 2 presents a general map of the delivery and receipt process for gift givers and recipients.

FIG. 3 shows an example flowchart/process map for the creations of a puzzle.

FIG. 4 is another flowchart/process map presenting the exemplary steps needed for a recipient to receive a puzzle.

FIG. 5 generally shows how a user will go about solving the puzzle and thus have access to their gift.

FIG. 6 illustrates another example of a game/puzzle creation process.

### DESCRIPTION

The systems and methods described below facilitate the gamification of gift giving, where a game/puzzle is used to enable the transfer of digital gifts. This involves the creation and completion of a gift giving transaction, wherein a first user (gift giver) will identify a gift for a second user (recipient) and will define the characteristics of a gift giving process. It is generally contemplated that the gift giving process will possibly include an electronic game, puzzle, scavenger hunt, riddle, challenge, etc., however many options are possible. The system will then create the details of the gift giving process to be completed. Stated differently, this creates a computer implemented methodology for the nesting or ‘boxing’ of digital gifts inside a customizable process (e.g., a game or puzzle). The first user will then provide the second user with access to the customized process gift giving process, thereby providing the second user with the ability to unlock or open the digital gift. The completion of said access process (e.g. the minigame or puzzle) functions as a digital passkey, granting the second user (i.e., recipient) access to the digital gift.

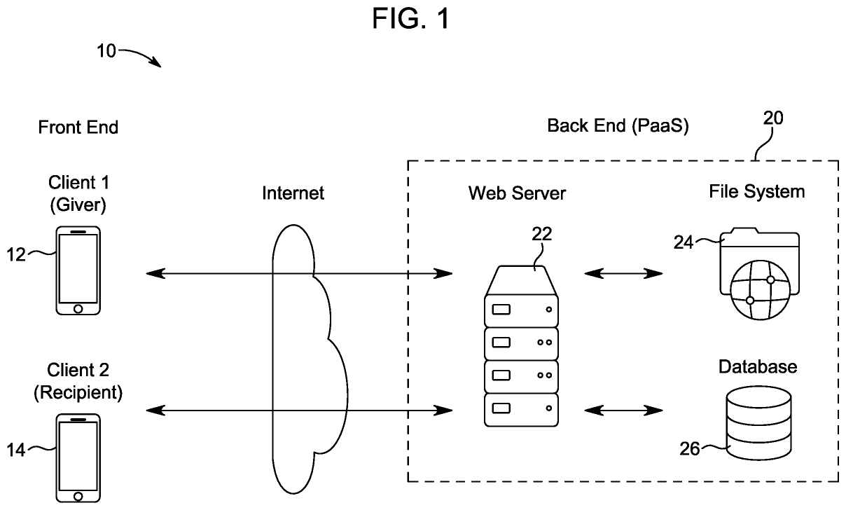

FIG. 1 generally shows one example of the infrastructure which can be used to support the gift giving process. More specifically, the system 10 includes a back-end system 20 which includes a web server 22, a file system 24 and a database 26. In this embodiment, the back-end system 20 is configured as a remotely hosted cloud based, platform as a service product (PaaS), which provides a more cost-effective method for rapidly developing and deploying upgrades and enhancements using third party developers. In this embodiment, back-end system 20 coordinates all communication as necessary and operates as a processing system capable of setting up, creating and facilitating the gamification process used for gift giving. Naturally, several alternatives are available.

As also shown in FIG. 1, a first client 12 (also referred to as Client 1 or a giver device), which can be a personal computing device such as a cell phone, tablet, laptop, personal computer, etc., will communicate with web server 22 via the internet 30. Similarly, a second client 14 (also referred to as Client 2 or the recipient), which can be also be a personal computing device such as a cell phone, tablet, laptop, personal computer, etc., will communicate with web server 22 via the internet 30 and which is associated with the recipient. It should be noted that the first client 12 and the second client 14 will receive information from respective users via various user interfaces and related programs/applications.

While certain examples discussed herein specific the use of a mobile device and installed applications, it is contemplated that this gift giving process could be carried out using other types of user interfaces, delivery mechanisms. For example, the system could be entirely web based, where interfaces and delivery is carried out via web browsers accessing the internet. Alternatively, uniquely configured applications could be used, which may be operable from personal computers, tablets, mobile devices, etc.

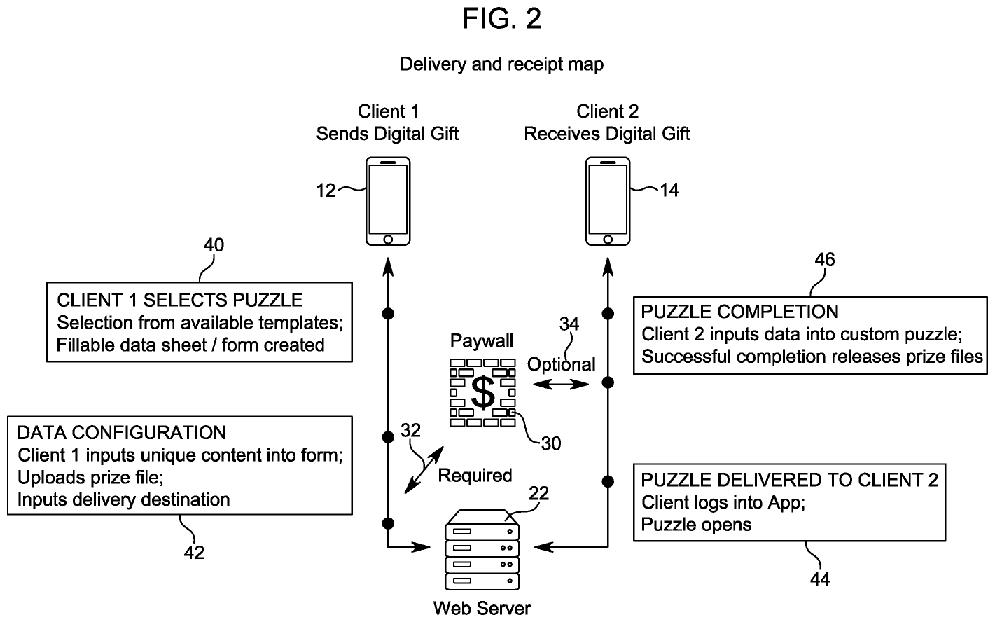

FIG. 2 generally illustrates the processes and data flow use to carry out the unique gift giving process. FIG. 2 also presents the way up and downstream communication to/from web servers 22 will occur in the contemplated system, by both first client 12 and second client 14 in a gift giving transaction. An initial paywall 30, with first client 12 on a first side thereof and with second client 14 on a second side thereof, will also accommodate the necessary commercial aspects of the gift giving transaction. As further discussed below, first client 12 will typically purchase the gift and pay for participation in the gift giving transaction, which is generally represented by having first client 12 on one side of the transaction and providing a first purchase point 32. An optional in-app purchase point 34 is provided on a second side to allow second client 14 with additional purchasing opportunities.

Referring again to FIG. 2, the general process map generally outlines how back-end system 20 will interact with first client 12 and second client 14 to complete the gift giving process in one embodiment. To start the process, a first user accesses the system 10 using first client 12 via an app, a website, a separate program or an appropriately configured application programming interface (API). As a first step, the first user will select the type of digital gift they would like to give to the recipient and the way they want to deliver the digital gift. In this example, first user is selecting to use a game or puzzle to be completed by the recipient before access to the digital gift is provided.

In more detail, the first user will select a template to submit information, thus allowing back-end system 20 to create the desired puzzle. In this embodiment, back-end system 20 will provide the first user with several small minigames, challenges or puzzle templates to choose from. As further discussed below, data is then input into the selected template and may specify how the use of technological assets or resources may be necessary to complete the game/puzzle. In some examples, these assets or resources include features or utilities that are inherent in mobile computing devices, including, but not limited to, camera, microphone, keypad and GPS. In other examples, the use of other technological assets may be specified, such as RFID tags, RFID readers, Infrared cameras, specialty sensors, etc. Alternatively, certain data provided by the first user will inherently signal to system 20 that these technological assets will be required, and back-end system 20 will automatically incorporate their use into the customized game/puzzle. The first user supplies the necessary visual, auditory or geospatial clues requested by the fillable template, thereby allowing back-end system 20 to automatically generate a game/puzzle that, dependent on the data supplied, can be unique to either the giver or the recipient, or both. Once all of the game/puzzle parameters are defined, the first user is then provided with an opportunity to incorporate the desired digital gift into the process. In one embodiment, first user will upload a digital file which forms the digital gift—a photo, audio/video file, document or web link. The first user then pays any fees for the puzzle or the digital gift, and then initiates a process to send the gift to the recipient. As further outlined below, the process proceeds by transmitting an invitation to the recipient allowing them to participate. This invitation, sent via email or other related electronic message, will allow the recipient to start the process. This could be accomplished via an appropriate link, or the transmission of a digital key, or any other access methodology.

Upon receipt of information allowing access to the gift award process (e.g. the game/puzzle) the recipient then has two primary options: Option 1) solve the puzzle by completing the game/puzzle supplied by the sender until a satisfactory result is achieved and the recipient is then given access to the gift; or Option 2) pay a fee to bypass solving the puzzle entirely—and take receipt of the gift (as mentioned below, the Easy Way Out, or EWO). These two steps are generally illustrated in FIG. 2 on the second user's side of the process which is carried out via second client 14.

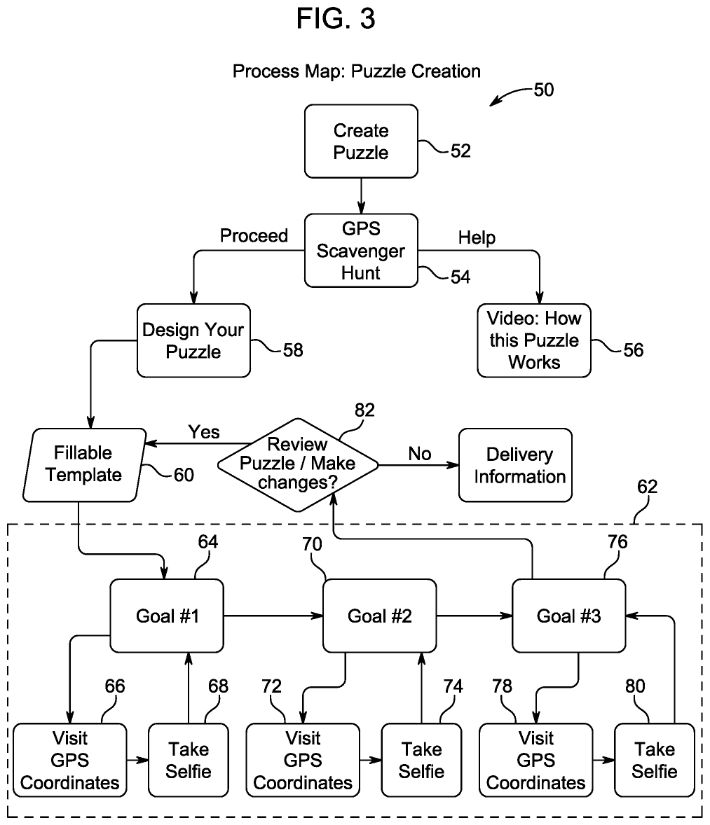

FIG. 3 illustrates one example flowchart illustrating how a GPS scavenger hunt-style puzzle is detailed from the point of puzzle creation to the point delivery information. Turning now to FIG. 3 in more detail, the process for the creation of a puzzle, game, or some other challenge, etc. by a first user on first client 12 is generally illustrated. In this particular example, a GPS scavenger hunt puzzle/challenge is being created. Starting at initial step 50, the process is initiated on first client 12 by the first user. In this particular example, the first user selects a GPS scavenger hunt as the desired game at step 54. Generally speaking, if the first user selects a help option, a video is then made available to the first user 1, illustrating how to carryout the puzzle creation process. Alternatively, if the first user decides to begin or proceed, they will start the puzzle design process 58. In this particular embodiment, a template is generated and provided to the first user, allowing them to fill in certain details regarding the desired GPS scavenger hunt. At this fillable template step 60, collected information may include a general title, theme, and personalized messages to the recipient generally outlining the anticipated process and creating excitement in the gift-giving process. Next, the details of the game/puzzle process 62 are defined. In this example, game/puzzle process 62 involves three separate goals or locations that the gift giver would like the recipient to visit before awarding their digital gift. At this point, the first user is allowed to define these goals or locations, identified in FIG. 3 as goal #1 64, which includes a set of GPS coordinates 66 and the necessary verification steps 68. In this example, the verification steps 68 anticipate taking selfies or pictures at the desired locations, thus confirming the recipient's completion of the defined steps or goal. Similarly, a goal #2 70 is defined by the first user, including identifying a second set of GPS coordinates 72 and a second verification process or verification requirement 74. In a similar manner, goal #3 76 is also defined by the first user, with another set of defined GPS coordinates 78 and third verification requirements 80.

Once the game/puzzle process 62 is defined the processing system 20 will generate the game/puzzle, which is then provide to the first user for review. Although not specifically the learned knowledge of processing system 20 will further define the exact details required by the defined game/puzzle, such as the exact GPS coordinates for the defined location, or the common name of the location corresponding to the specified GPS coordinates. The processing system 20 may also identify landmarks at the defined location and specify further details required for a selfie picture (e.g. a particular monument may be required in the background). In this manner, the game/puzzle creation can be both customized and detailed.

At a puzzle review step 82 the first user can determine whether changes to the defined game/puzzle are necessary. If necessary, the process will flow back to template step 60, allowing the user to redefine any of the parameters set forth therein. However, if no changes are necessary, the first user is brought to a delivery options mechanism, 84 where details regarding how the gamified digital gift will be delivered to the recipient.

While the above process outlines how a scavenger hunt type game is crated, it is contemplated that several types of “games” could be created using a similar process. As example, this could include the creation of a crossword puzzle, a word search, a tile slide game, a jigsaw puzzle, a trivia challenge, a memory challenge, a location identification challenge, a photo identification challenge, etc. In addition, participatory challenges are contemplated such as sing-with-me, dance me free, music duplication, selfie photo challenge, etc. Generally speaking, many different types of activities could be contemplated which encourage user participation and/or can be unique to the gift giver and the recipient. These games/puzzles are created by processing system using specialized processing, or thought the use of multiple tools that cooperate with one another. For example, it is possible that computing system 20 could connect to or call various outside computing resources that are specifically configured to create the desired games, based upon the parameters provided. This use of outside computing resources is achieved without requiring any additional action by the gift giver (and typically without the gift giver's knowledge).

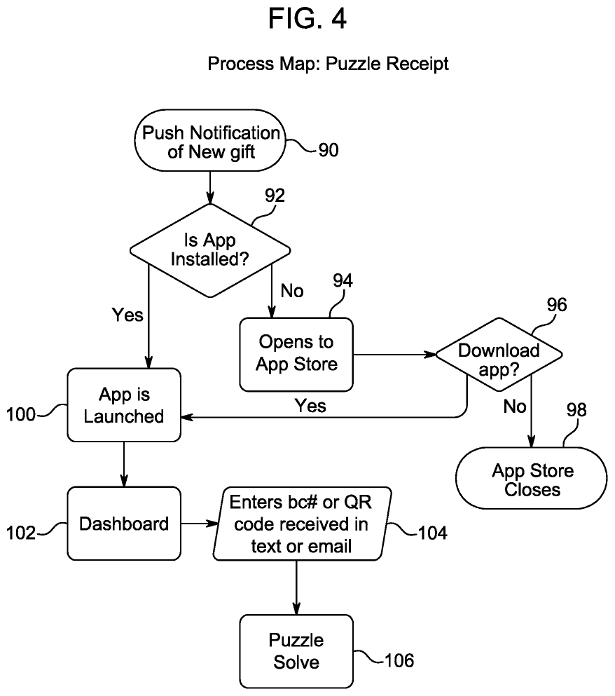

FIG. 4 is yet another flowchart/process map, but now illustrating the receipt of the gift by second client 14, from the point of notification to the commencement of puzzle solution. As shown in FIG. 4, a push notification indicative of a new gift 90 is the first step in the process of delivering the packaged digital gift to a recipient. At step 92, the process will first question the recipient as to whether the gamification app is installed. If not, the process will prompt a user to open the relevant apt store 94, which may encompass the Google play store, or the Apple App store thereby allowing user to download the app. Again, this example contemplates the use of an appropriate application installed on a user device. It will be recognized that a similar notice could be sent via email or text prompting access to a web-based interface. Next the process will confirm at step 96 whether the app is installed. If not, at step 98, the app store will close, prompting communication of back to the game delivery system for further steps which are not shown in FIG. 4.

If the recipient indicates at step 92 that the app is installed, or at step 96 the app is successfully downloaded, the app is then launched at step 100, thereby causing a game dashboard to open at step 102. To provide a desired level of security, verification is carried out by requiring a recipient to enter a QR Code or confirmation number previously received via text or email at step 104. Once verification has been successfully completed, the puzzle solve process 106 begins, which is described in further detail below.

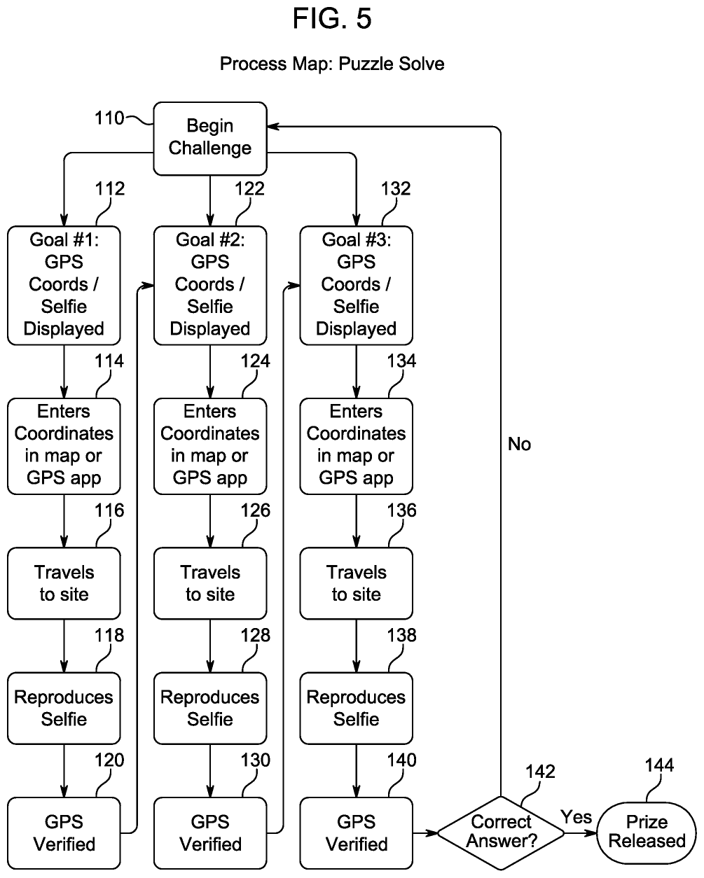

FIG. 5 presents the process of solving of the previously mentioned scavenger hunt (GPS) puzzle, from the point of commencement to the release of the prize or gift previously uploaded via first client 12. As outlined above, the first user has defined the steps and processes that they anticipate the recipient carrying out in order to receive the identified digital gift. This example is generally illustrated in FIG. 5, wherein the challenge/puzzle begins at step 110 which allows the recipient to initiate or start the defined process. Again, the example set forth above in relation to FIG. 3 involves a scavenger hunt type puzzle, wherein the recipient is required to visit defined locations and verify their presence.

As outline in FIG. 5, goal #1 involves the collection of GPS coordinates and completion of selfie requirements, which are started at step 112. Next, the recipient is provided with mechanisms to enter the coordinates on a map 114 and thus given time to travel to the identified site 116. Again, the verification step contemplated herein involves the completion of a picture or selfie 118 at the desired location. At this point in the game/puzzle solving process, a mechanism is used to record the selfie/picture and also verify the GPS location, thus confirming where the picture was taken. Next, upon GPS verification and thus completion of goal #1 at verification step 120, the method will move back to begin solving or satisfying goal #2 122. A similar process is then started which is directed toward carrying out goal #3 132, until the system will eventually determine that all goals have been successfully satisfied and the correct “answer” has been provided at step 142. Stated differently, the system will confirm that the three goals have been completed, satisfying the requirements specified by the gift giver. Those skilled in the art will recognize that this involves the exchange of many unique signals and the processing of unique information. As mentioned above, the use of GPS location indicators is central to the process set forth above. Also, the communication of digital images and the processing of those images to ensure that desired matches are obtained will be necessarily carried out by the processing system which manages the gamification process.

If the defined steps have all been satisfactorily completed, codes and appropriate mechanisms are then released to the recipient, allowing them to retrieve or obtain their digital gift. In one example, this may include the delivery or access to a predetermined gift card, allowing with all authorization codes, etc. Alternatively, access may be provided to a storage box or mailbox of some type, where a physical gift could be provided using the defined digital access codes. As another alternative, the gift could conceivably be a nonfungible token NFP, which is then provided to the user along with the related coding, which makes the NFT unique. Additional alternatives are possible and contemplated as being within the scope of the embodiment set forth above.

As mentioned above, the gifting systems outlined in FIGS. 1-5 can exist as a mobile device application that will require installation on both the giver and recipient devices (i.e. first client and second client) and communication with a computing system 20 in order for the transaction to complete. This computer implemented methodology is distributed via an online mobile computing device, through a hosted, cloud-based infrastructure, to a recipient who will also use a mobile computing device to unlock or ‘unbox’ the digital gift. This latter is achieved by correctly duplicating the requisite data supplied by the sender of the gift. That said, a similar gift giving process could be supported in a web-based system, with the user access provided via web browsers.

As mentioned above, the recipient is typically provided with a way to access the desired gift without completing the puzzle. This Easy Way Out (EWO) is provided as a side mechanism which would operate in parallel with the game completion process. It is contemplated that the EWO could involve a buyout option, which would then present the user with a payment options. For example, they may be transferred to a payment system, which is configured to be on an opposite side of a paywall than the gifting system.

Although not specifically presented as part of creating the scavenger hunt game discussed above, it is contemplated that the gift giver is provided with the opportunity to set a level of difficulty. In the scavenger hunt example, the difficulty will generally be driven by the locations selected and the type of verification requirements included. That said, when creating alternative games/puzzles, such as crossword puzzles, jigsaw puzzles, word search puzzles, the came creation process will allow for a level of difficulty to be selected. Also, various levels of automation can be used in the game creation process. On one extreme, the system will allow the gift giver to configure the game/puzzle entirely on their own. As another option, the gift giver can define general parameters, and the game creation system will then generate the game/puzzle using these parameters.

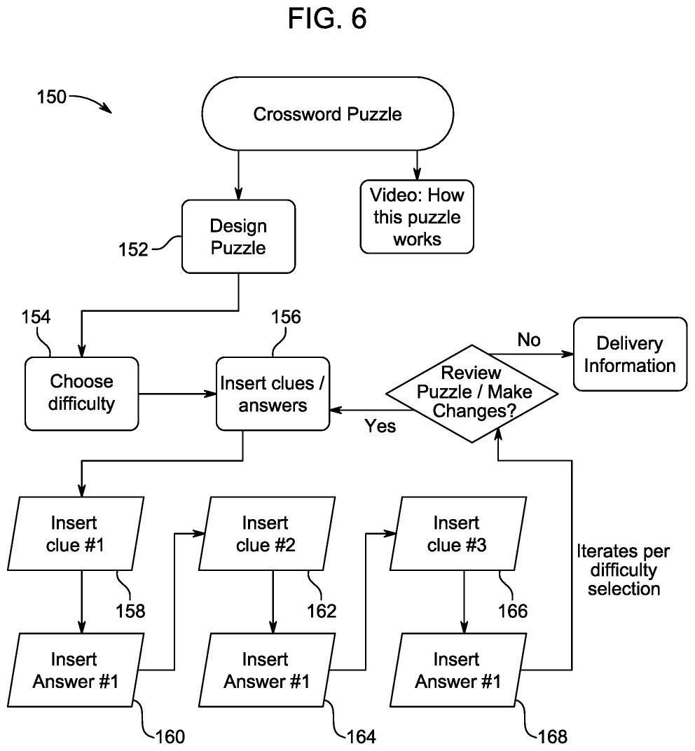

In addition to defining a level of difficulty, the gift giver is provided with the mechanism to define a level of assistance to the recipient. More specifically, the gift giver is given the opportunity to provide the recipient with clues as they complete the game process. In certain instances, this is an inherent part of the game/puzzle, such as a crossword puzzle/game. Turning now to FIG. 6, one example of the creation of a crossword puzzle is presented. Starting at the design puzzle step 152, the first user (i.e. gift giver) begins the process of creating the crossword game/puzzle. As a first step, the user can select difficulty at step 154, which will provide a game creation system with a general parameter to use when designing the game/puzzle. It will be recognized that game creation system can be housed within and part of back end system 20 discussed above. Next, the gift giver will begin to insert clues/answers. As illustrated, several steps are completed to insert a number of clues and related answers (see, steps 156-166). With this option, the gift giver is provided with the opportunity to customize the puzzle in many different ways. With this information, the game creation system can then configure a crossword game/puzzle. Although not specifically illustrated, the gift giver may be provided with the option of providing multiple clues to the recipient as they play/complete the puzzle.

The examples set forth above generally contemplate the creation of a game/puzzle that is presented and solved by an individual recipient. That said, it is possible that the game/puzzle can be created and presented to a group of people, with the first person to complete the game/puzzle will receive a digital gift. As another option, anyone in the group that completes the game/puzzle will be awarded a digital gift.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A method of giving and receiving a digital gift, comprising:
receiving input from a first user which defines the digital gift;
providing a user interface to the first user configured to allow the first user to input information;
receiving, by a processing system, information to from the first user defining a set of characteristics for a customized gift access process which will enable a second user to access to the digital gift;
creating, by the processing system, the customized gift access process based upon the characteristic received from the first user, wherein the customized gift access process will identify at least one resource needed by the second user and a plurality of steps required by the second user to generate a satisfactory result;
transmitting an invitation to participate in the gift access process to the user, wherein the invitation provides electronic access allowing the user to participate in the gift access process using a second user interface provided to the second user;
transmitting information to the second user and receiving information from the second user to allow the second user to attempt to carry out the plurality of steps using the second user interface and the at least one resource; and
determining if the second user has satisfactorily completed the plurality of steps, and upon satisfactorily completing the plurality of steps, transmitting identifying information and access information related to the digital gift thereby allowing the second user to receive the digital gift.

2. The method of claim 1, wherein the second user interface is on a personal computing device of the second user and wherein the at least one resource comprises a utility existing on the personal computing device.

3. The method of claim 2 wherein the utility is a camera, audio recorder or GPS device.

4. The method of claim 1 wherein the second user interface is on a personal computing device of the second user and the customized gift access process is a game played on the personal computing device.

5. The method of claim 4 wherein the game requires the use of a GPS receiver contained within the personal computing device to generate location information.

6. The method of claim 1 wherein the customized gift access process is selected from a scavenger hunt challenge, a crossword puzzle, a word search, a tile slide game, a jigsaw puzzle, a trivia challenge, a memory challenge, a location identification challenge, a photo identification challenge, a dance challenge, a music identification challenge, or a singing challenge.

7. A system for supporting a gamified gift giving process, comprising:
a computing system configured to receive a request from a first user to create a digital game/puzzle which will be used as a digital key to allow for the presentation of a digital gift to a second user, wherein the computing system is further configured to receive a plurality of game parameters from the first user which define a digital game type, a plurality of customized game requirements, a recipient and a digital gift;
the computing system further configured to create the digital game/puzzle using the digital game type and the plurality of customized game requirements received from the first user and present the digital game/puzzle to the first user and to receive changes, and to subsequently finalize the digital game/puzzle;
wherein the computing system is further configured to provide access to the recipient with access to the digital game/puzzle, and to provide the recipient with an interface to allow the recipient to play the digital game/puzzle, wherein the digital game/puzzle will require the recipient to provide a plurality of digital inputs to the computing system in order to successfully complete the digital game/puzzle, the computing system producing a confirmation signal if the plurality of digital inputs satisfy the plurality of customized game requirements, wherein the confirmation signal is then provided to the recipient, the confirmation signal providing digital information necessary to provide access to the digital gift; and
accommodating access to the digital gift by the recipient, which comprises the use of a digital key provided by the computing system to the recipient.

8. The system of claim 7 wherein the digital game/puzzle is selected from a scavenger hunt challenge, a crossword puzzle, a word search, a tile slide game, a jigsaw puzzle, a trivia challenge, a memory challenge, a location identification challenge, a photo identification challenge, a dance challenge, a music identification challenge, or a singing challenge.

9. The system of claim 7 wherein the plurality of customized game requirements comprise a location indicator to be provided by a recipient using a GPS locator.

10. The system of claim 7 wherein the creation of the digital game/puzzle will incorporate a difficulty factor provided by the first user and learned knowledge related to the created game/puzzle.
